(19) United States
(12) Patent Application Publication
(10) Pub. No.: US 2014/0041055 A1
(43) Pub. Date: Feb. 6, 2014

(54) SYSTEM AND METHOD FOR ONLINE ACCESS CONTROL BASED ON USERS SOCIAL NETWORK CONTEXT

(71) Applicants: Shmuel Shaffer, Palo Alto, CA (US); Doree Duncan Seligmann, New York, NY (US); Reinhard P. Klemm, Basking Ridge, NJ (US)

(72) Inventors: Shmuel Shaffer, Palo Alto, CA (US); Doree Duncan Seligmann, New York, NY (US); Reinhard P. Klemm, Basking Ridge, NJ (US)

(73) Assignee: AVAYA INC., Basking Ridge, NJ (US)

(21) Appl. No.: 13/567,301

(22) Filed: Aug. 6, 2012

(51) Int. Cl. G06F 21/00; G06F 15/16

(52) U.S. Cl. 726/28; 709/204

(57) ABSTRACT

System and method to control access by a user to an online service, the method including: receiving a request from a user to use an application; identifying, via a processor of a computing device, a social networking characteristic of the user; classifying the user based upon the social networking characteristic, to produce a classification of the user; and controlling an access to the online service based upon the classification of the user. The characteristic may be public or private. Controlling access may include permitting, impeding, or facilitating access. Display of a link may be changed, and/or the processing of the link if selected may be changed. Users may be classified at least as preferred, malicious, non-malicious, non-target and generic default.

### BACKGROUND

1. Field of the Invention

The present disclosure relates to user interfaces and more specifically to controlling online access based on social network user profiles.

2. Description of Related Art

Especially in the last decade, a significant amount of research has been devoted to the control of online access and in particular of Web applications, encompassing applications that load user interfaces over a network into users' Web browsers. The user interfaces can range from simple HTML pages to complex thin clients, and the server-side part of the application can range from simple URL/resource mappings on a Web server to full-fledged enterprise software systems.

There is no consistent definition of the term online access control in the context of Web applications or beyond. In one definition, control of online access includes any action that makes a link offered to a user personalized to information about the user. A drawback of this approach is that a website must implement a framework for control of online access, and then the web site must be able to gather relevant information about the user. These hurdles present a significant barrier to widespread personalization of online access control.

Research has been devoted to control of online personalization. Many commercial providers have deployed web applications that exhibit personalization to some extent. In most of these applications, control of online personalization is mostly internal and transparent to the user, with an additional small amount of explicitly gathered data about the user. Despite the promise and success of these research and commercial systems, however, a number of challenges have limited the attained degree of control of online personalization. Therefore, control of online personalization of Web applications has not reached its full potential.

Customers and potential customers of a business often post messages on social networking sites. For example, customers may post questions about a product, provide a feedback rating, discuss a problem or grievance with the product, the service, or the business, or the like. The business may find it valuable to be aware of such messages and respond to them on the social networking site. The business may also find it valuable to be aware of similar messages related to competitors' products, as an opportunity to recruit a new customer of the business by responding to the message.

Generic response controls may be used, but which often may be inappropriate with respect to the value of the customer who uses them versus the cost of resources used to service that customer who uses the controls. “Controls” as a noun may also be referred to herein as “links.” Achieving an improved balance of the value of a customer and the resources used to service that customer may involve a human effort by the business to respond, thereby incurring relatively greater business cost. Responses may contain links to online resources such as online customer service applications, contact center callback services, chat/email links to a contact center used by the business. Costs to the business of these links may increase as usage of these links by customers increases.

Businesses find it advantageous to limit the usage of online access links (including online resources) by less valuable customers. Others have addressed this problem in the past by:

a) Access control lists (“ACL”) for online resources, which can be used to restrict access to the online resources to preconfigured, preapproved users. The access control list can implicit link a user's online identity to a resource already owned by the user such as a bank account, credit card, customer ID, employee ID.

b) Registration for an online account with a business. Access to online resources would be allowable only from a registered account, allowing the business to revoke the user account in case of abusive user behavior.

The current practice for social network based contact is simply for the business staff to detect and remember undesirable users. This is a manual operation which may overwhelm the operation of a call center under normal circumstances. A manual process is prohibitively slow under a Denial of Service (“DOS”) attack. To reduce the risk of unauthorized use of online resources in other parts of the Web, access control lists and registration for online accounts before allowing the user to use online resources are widespread.

The manual approach to detecting and remembering undesirable users on social networks is time-consuming, costly, and ineffective even if there is a large staff and for the early detection of the abuse of online resources referenced in business responses, such as customer service applications, callbacks, etc. An undesirable user could, for example, post a question on a business Facebook Page and wait for the business to respond with a callback button for the business contact center. Then, the undesirable user could deploy software that triggers the callback mechanism numerous times or could manually trigger the callback mechanism numerous times. Excluding undesirable users from accessing online resources by mandating a login into a registered account is often not practical and makes it more difficult for authorized users to access the resources.

Therefore, a need exists to provide a faster and more effective method to control online access, in order to conserve support resources for authorized users rather than undesirable users, and ultimately to provide improved customer satisfaction to authorized users.

### SUMMARY

Embodiments in accordance with the present invention distinguish between social network users that have a high value to a business and users who have a low or lower value. The latter group may include users who are outside a target demographic of the business, and may also include users whose behavior is known or likely to be contrary to the interests of the business. For example, low value users may have posted spam to the attention of the business on the social network. Low value users may have been originators of denial of service attacks. Low value users may have tried to hack into the business computers or defaced the social network page of the business. Low value users may have falsified their identities or pretended to be who they are not.

Embodiments in accordance with the present invention include an online access control mechanism that provides abilities to: a) identify low value users and avoid drawbacks (e.g., cost, danger, etc.) of responding to social network posts from low value users; b) block online access by low value users to business resources such as documents, the business contact center, individuals in the business, etc.; c) identify high-value users and preferentially respond to their social network posts; and d) identify high-value users who not only are important enough to warrant responses to their social network posts but also important enough to gain online access to business resources such as documents, the business contact center, and individuals in the business.

Disclosed herein is a method and system for controlling online access to web applications or other network-enabled applications according to users' profiles on a public and/or private social network. The platform emphasizes ease-of-use, flexibility, and general applicability across application domains. Web applications and network-enabled applications, as referred to herein, refer to applications which may be interacted with in some manner by a person using a computing device. The interaction may include initiation, invoking some additional functionality, opening a communication channel, terminating, and so forth. The computing device may include PCs, smart phones, laptop computers, tablet computers, a thin client capable of rendering a web page or web form, and so forth.

Although some of the examples discussed herein involve Web applications, the same principles can be applied to virtually any other application with a user interface and access to social networking data either online or offline. Web interfaces were selected for the examples because Web platforms greatly facilitate technical execution of the customized user interfaces and explanations thereof.

Further, controlling online access to web applications can include actions taken by the Web application provider, often a business, to change the access permissions of a user based on the user's persona and context but not necessarily to the user's taste. This definition allows an application provider to generate customized user interfaces for a Web (or other) application regardless of users' tastes and whose primary intention is to support a goal of the provider. Examples of such goals are reducing operational expenses, increasing product sales, more accurately presenting products and services that have a high degree of variability across the targeted customer base, and abiding by laws that govern the products or services rendered.

Embodiments in accordance with the present invention provide a method to control access by a user to an online service, including: receiving a request from a user to use an application; identifying, via a processor of a computing device, a social networking characteristic of the user; classifying the user based upon the social networking characteristic, to produce a classification of the user; and controlling an access to the online service based upon the classification of the user.

The social networking characteristic may include: a geographic source identifier of other posts from the user; an IP address of the user; and/or a subnet address of the user.

The social networking characteristic may include publicly available information or private information. If private information is accessed, authorization may be requested from the user in order to access the social networking data characteristic.

In some embodiments, access control may include permitting the user to use the online service. In some embodiments, the user may request to use the online service, but the request may be discarded. Optionally, the user may be informed of the reason if their request is discarded. Optionally, controlling access to online services includes determining whether to display the online link to the user.

In some embodiments, online users may be classified based upon the social networking characteristic. Classification may include malicious, non-target and preferred. Preference in accessing the online service may be influenced by the classification.

Embodiments in accordance with the present invention include a system configured to implement a method in accordance with an embodiment of the present invention.

The preceding is a simplified summary of embodiments of the disclosure to provide an understanding of some aspects of the disclosure. This summary is neither an extensive nor exhaustive overview of the disclosure and its various embodiments. It is intended neither to identify key or critical elements of the disclosure nor to delineate the scope of the disclosure but to present selected concepts of the disclosure in a simplified form as an introduction to the more detailed description presented below. As will be appreciated, other embodiments of the disclosure are possible utilizing, alone or in combination, one or more of the features set forth above or described in detail below.

### BRIEF DESCRIPTION OF THE DRAWINGS

The above and still further features and advantages of the present invention will become apparent upon consideration of the following detailed description of embodiments thereof, especially when taken in conjunction with the accompanying drawings wherein like reference numerals in the various figures are utilized to designate like components, and wherein:

FIG. 1 is a block diagram depicting an example system in accordance with an embodiment of the present invention;

FIG. 2 illustrates at a high level of abstraction an example architecture for a personalization programming platform, in accordance with an embodiment of the present invention;

FIG. 3 illustrates a method to control online access, in accordance with an embodiment of the present invention; and

FIG. 4 illustrates a method to control online access, in accordance with an embodiment of the present invention.

The headings used herein are for organizational purposes only and are not meant to be used to limit the scope of the description or the claims. As used throughout this application, the word “may” is used in a permissive sense (i.e., meaning having the potential to), rather than the mandatory sense (i.e., meaning must). Similarly, the words “include”, “including”, and “includes” mean including but not limited to. To facilitate understanding, like reference numerals have been used, where possible, to designate like elements common to the figures. Optional portions of the figures may be illustrated using dashed or dotted lines, unless the context of usage indicates otherwise.

### DETAILED DESCRIPTION

The disclosure will be illustrated below in conjunction with an exemplary communication system. Although well suited for use with, e.g., a system using a server(s) and/or database(s), the disclosure is not limited to use with any particular type of communication system or configuration of system elements. Those skilled in the art will recognize that the disclosed techniques may be used in any communication application in which it is desirable to utilize social media to gather information about users or potential users.

Embodiments in accordance with the present invention provide a system and method for identifying malicious and/or undesirable users, and excluding them from establishing connection with live agents. Embodiments in accordance with the present invention also provide a system and method for identifying non-malicious users, and facilitating communication of non-malicious users with live agents.

The exemplary systems and methods of this disclosure will also be described in relation to software, modules, and associated computing hardware. However, to avoid unnecessarily obscuring the present disclosure, the following description omits well-known structures, components and devices that may be shown in block diagram form, are well known, or are otherwise summarized.

In the following detailed description, numerous specific details are set forth in order to provide a thorough understanding of embodiments or other examples described herein. In some instances, well-known methods, procedures, components and circuits have not been described in detail, so as to not obscure the following description. Further, the examples disclosed are for exemplary purposes only and other examples may be employed in lieu of, or in combination with, the examples disclosed. It should also be noted the examples presented herein should not be construed as limiting of the scope of embodiments of the present invention, as other equally effective examples are possible and likely.

As used herein in connection with embodiments of the present invention, the term “contact” (as in “customer contact”) may refer to a communication from a customer or potential customer, in which a request is presented to a contact center. Similarly the term “contact” (as in “customer contact”) may refer to a communication from a contact center, in which a request is presented to a potential customer. The request can be by way of any communication medium such as, but not limited to, a telephone call, e-mail, instant message, web chat, and the like.

As used herein in connection with embodiments of the present invention, the term “customer” denotes a party external to the contact center irrespective of whether or not that party is a “customer” in the sense of having a commercial relationship with the contact center or with a business represented by the contact center. “Customer” is thus shorthand, as used in contact center terminology, for the other party to a contact or a communications session.

The terms “switch,” “server,” “contact center server,” or “contact center computer server” as used herein should be understood to include a Private Branch Exchange (“PBX”), an Automated Contact Distribution (“ACD”), an enterprise switch, or other type of telecommunications system switch or server, as well as other types of processor-based communication control devices such as, but not limited to, media servers, computers, adjuncts, and the like.

As used herein, the term “module” refers generally to a logical sequence or association of steps, processes or components. For example, a software module may comprise a set of associated routines or subroutines within a computer program. Alternatively, a module may comprise a substantially self-contained hardware device. A module may also comprise a logical set of processes irrespective of any software or hardware implementation.

The term “computer-readable medium” as used herein refers to any tangible storage and/or transmission medium that participates in storing and/or providing instructions to a processor for execution. Such a medium may take many forms, including but not limited to, non-volatile media, volatile media, and transmission media. Non-volatile media includes, for example, NVRAM, or magnetic or optical disks. Volatile media includes dynamic memory, such as main memory. Common forms of computer-readable media include, for example, a floppy disk, a flexible disk, hard disk, magnetic tape, or any other magnetic medium, magneto-optical medium, a CD-ROM, any other optical medium, punch cards, paper tape, any other physical medium with patterns of holes, RAM, PROM, EPROM, FLASH-EPROM, solid state medium like a memory card, any other memory chip or cartridge, a carrier wave as described hereinafter, or any other medium from which a computer can read. A digital file attachment to e-mail or other self-contained information archive or set of archives is considered a distribution medium equivalent to a tangible storage medium. When the computer-readable media is configured as a database, it is to be understood that the database may be any type of database, such as relational, hierarchical, object-oriented, and/or the like. Accordingly, the disclosure is considered to include a tangible storage medium or distribution medium and prior art-recognized equivalents and successor media, in which the software implementations of the present disclosure are stored.

Various embodiments of the disclosure are discussed in detail below. While specific implementations are discussed, it should be understood that this is done for illustration purposes only. A person skilled in the relevant art will recognize that other components and configurations may be used without parting from the spirit and scope of the disclosure.

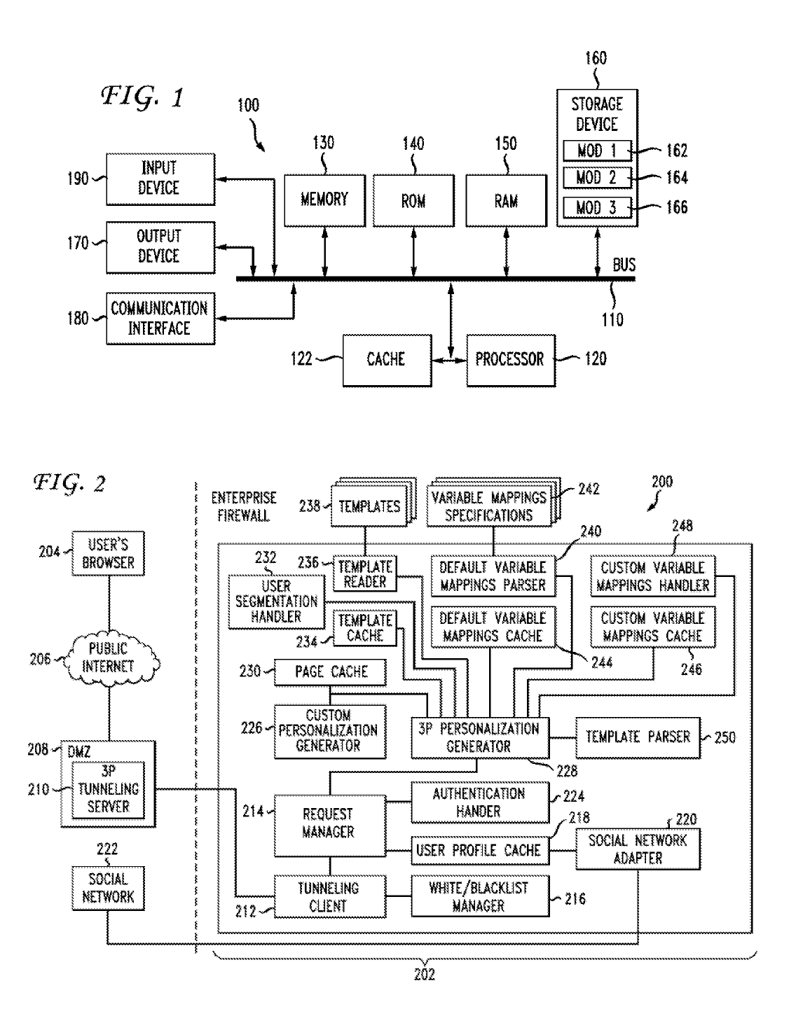

With reference to FIG. 1, an exemplary system 100 includes a general-purpose computing device 100, including a processing unit (CPU or processor) 120 and a system bus 110 that couples various system components including the system memory 130 such as read only memory (ROM) 140 and random access memory (RAM) 150 to the processor 120. The system 100 can include a cache 122 of high speed memory connected directly with, in close proximity to, or integrated as part of the processor 120. The system 100 copies data from the memory 130 and/or the storage device 160 to the cache 122 for quick access by the processor 120. In this way, the cache provides a performance boost that avoids processor 120 delays while waiting for data. These and other modules can control or be configured to control the processor 120 to perform various actions. Other system memory 130 may be available for use as well. The memory 130 can include multiple different types of memory with different performance characteristics. It can be appreciated that the disclosure may operate on a computing device 100 with more than one processor 120 or on a group or cluster of computing devices networked together to provide greater processing capability. The processor 120 can include any general purpose processor and a hardware module or software module, such as module 1 162, module 2 164, and module 3 166 stored in storage device 160, configured to control the processor 120 as well as a special-purpose processor where software instructions are incorporated into the actual processor design. The processor 120 may essentially be a completely self-contained computing system, containing multiple cores or processors, a bus, memory controller, cache, etc. A multi-core processor may be symmetric or asymmetric.

The system bus 110 may be any of several types of bus structures including a memory bus or memory controller, a peripheral bus, and a local bus using any of a variety of bus architectures. A basic input/output system (BIOS) stored in ROM 140 or the like, may provide the basic routine that helps to transfer information between elements within the computing device 100, such as during start-up. The computing device 100 further includes storage devices 160 such as a hard disk drive, a magnetic disk drive, an optical disk drive, tape drive or the like. The storage device 160 can include software modules 162, 164, 166 for controlling the processor 120. Other hardware or software modules are contemplated. The storage device 160 is connected to the system bus 110 by a drive interface. The drives and the associated computer readable storage media provide nonvolatile storage of computer readable instructions, data structures, program modules and other data for the computing device 100. In one aspect, a hardware module that performs a particular function includes the software component stored in a non-transitory computer-readable medium in connection with the necessary hardware components, such as the processor 120, bus 110, display 170, and so forth, to carry out the function. The basic components are known to those of skill in the art and appropriate variations are contemplated depending on the type of device, such as whether the device 100 is a small, handheld computing device, a desktop computer, or a computer server.

Although the exemplary embodiment described herein employs the hard disk 160, it should be appreciated by those skilled in the art that other types of computer readable media which can store data that are accessible by a computer, such as magnetic cassettes, flash memory cards, digital versatile disks, cartridges, random access memories (RAMs) 150, read only memory (ROM) 140, a cable or wireless signal containing a bit stream and the like, may also be used in the exemplary operating environment. Non-transitory computer-readable storage media expressly exclude media such as energy, carrier signals, electromagnetic waves, and signals per se.

To enable user interaction with the computing device 100, an input device 190 represents any number of input mechanisms, such as a microphone for speech, a touch-sensitive screen for gesture or graphical input, keyboard, mouse, motion input, speech and so forth. An output device 170 can also be one or more of a number of output mechanisms known to those of skill in the art. In some instances, multimodal systems enable a user to provide multiple types of input to communicate with the computing device 100. The communications interface 180 generally governs and manages the user input and system output. There is no restriction on operating on any particular hardware arrangement and therefore the basic features here may easily be substituted for improved hardware or firmware arrangements as they are developed.

For clarity of explanation, the illustrative system embodiment is presented as including individual functional blocks including functional blocks labeled as a “processor” or processor 120. The functions these blocks represent may be provided through the use of either shared or dedicated hardware, including, but not limited to, hardware capable of executing software and hardware, such as a processor 120, that is purpose-built to operate as an equivalent to software executing on a general purpose processor. For example the functions of one or more processors presented in FIG. 1 may be provided by a single shared processor or multiple processors. (Use of the term “processor” should not be construed to refer exclusively to hardware capable of executing software.) Illustrative embodiments may include microprocessor and/or digital signal processor (DSP) hardware, read-only memory (ROM) 140 for storing software performing the operations discussed below, and random access memory (RAM) 150 for storing results. Very large scale integration (VLSI) hardware embodiments, as well as custom VLSI circuitry in combination with a general purpose DSP circuit, may also be provided.

The logical operations of the various embodiments are implemented as: (1) a sequence of computer implemented steps, operations, or procedures running on a programmable circuit within a general use computer, (2) a sequence of computer implemented steps, operations, or procedures running on a specific-use programmable circuit; and/or (3) interconnected machine modules or program engines within the programmable circuits. The system 100 shown in FIG. 1 can practice all or part of the recited methods, can be a part of the recited systems, and/or can operate according to instructions in the recited non-transitory computer-readable storage media. Such logical operations can be implemented as modules configured to control the processor 120 to perform particular functions according to the programming of the module. For example, FIG. 1 illustrates three modules Mod 1 162, Mod 2 164 and Mod 3 166 which are modules configured to control the processor 120. These modules may be stored on the storage device 160 and loaded into RAM 150 or memory 130 at runtime or may be stored as would be known in the art in other computer-readable memory locations.

Having disclosed some components of a computing system, the disclosure now returns to a discussion of customizing and controlling online access based on social networking data.

Online access control in general and of web applications in particular promises many benefits for web site operators and/or provider as well as end users. Controlling online access to web applications can create a stronger commercial bond between end users and the web site operator, facilitate use of the web applications, and enhance their effectiveness for users and the provider. In recent years, public and private social networks have proliferated and attracted a large number of users. Consequently, the amount of personal data that users have voluntarily placed online, including social network user profiles, has exploded. Social network user profiles constitute an as-of-yet untapped resource for controlling online access to web applications and other software.

Malicious users (e.g., hackers, pranksters, competitors, curmudgeons, etc.) may exploit social network posts and online resources reachable from business responses. Such users can damage business interests by driving up the cost to the business or even engage in a high-level denial of service attack. In such an attack the malicious user may deploy software that auto-generates social network posts and possibly exercises online resources referenced in business responses to keep the business contact center, marketing department, or online services artificially busy. The same type of users, for the same reasons, and with similar mechanisms can create artificial request in a business Web portal where we often find call-me buttons or online ways to request customer service through email, chat, etc.

Often, a business will also like to exclude classes of non-malicious users from using or receiving at least certain types of online customer service and/or consuming online resources. For example, a business might want to restrict users based on user location (e.g., users outside the business target area) or based on age (e.g. target age, income level, education level, etc. for their products or services). These non-malicious users may be referred to herein as non-target users. The restriction may range from discouraging usage of resource-intensive customer service (e.g., making it harder to find), to not offering or allowing resource-intensive customer service to certain customers (e.g., not offering a chat option, or blocking fulfillment of a chat request if selected), to not offering any customer service at all (e.g., not listing a phone number or email address). Access to the requested customer service by non-target users may also be impeded, for instance by assigning such users low priority, non-preferential queue placement, etc.

Conversely, if a user is determined to be particularly valuable for some reason (e.g., spending patterns, demographic membership, being a trend setter, etc.), embodiments in accordance with the present invention may facilitate access to an online control by making such links easier to find or use, enhanced service if selected (e.g., live operator rather than an IVR system; preferential queue placement), and so forth.

Various exemplary customer service scenarios are described below. In these examples, undesirable users include non-target users as well as the malicious users and users who may otherwise be considered to be undesirable or non-priority. Embodiments in accordance with the present invention mitigate some of the risks to the business from undesirable user requests on social networks and elsewhere online.

Suppose a user posts a complaint in a social media forum regarding the quality of a product that was purchased from a vendor. In accordance with an embodiment of the present invention, a social-media-based call center application may be used to identify the complaint and provide a certain level of customer care and customer support. For example, the application may generate an automated reply in the social media forum such as “We regret the issues you have experienced with our product. Please click on the URL below and you will be connected to an agent who will be happy to help you get product replacement,” followed by a relevant, clickable URL link.

If the user clicks on the specified URL, the user's computing device will launch a browser-based application that establishes a live communications connection (e.g., a video call) between the user and an agent of the vendor. However, since the reply to the user's complaint is posted on a social media forum, undesirable users may be able to see the message exchange and use the specified URL for malicious purposes such as a Denial of Service (“DOS”) attack or to otherwise access and/or waste customer service resources. Embodiments in accordance with the present invention will detect undesirable users and restrict or block access by such undesirable users so that fewer customer agent resources will be wasted on undesirable users. For example, if a user is unauthorized to use or otherwise access chat customer service resources, such a user clicking on a chat window request may result in an error message, or a notification message denying the request, or a no-response timeout, and so forth. The undesirable user may still see links to request resource-intensive customer service options, but those links will be illusory for undesirable users because their requests will be restricted, discarded, or otherwise blocked by embodiments in accordance with the present invention.

In some embodiments in accordance with the present invention, the notification message denying the request may be posted as one single message to a social media site (e.g., a social media site undergoing a DOS attack) or other public forum, in order to inform network users that an attack has been identified and that the previously provided link is being disabled. Therefore, the embodiment replies only once to all attempts to request an agent, rather than reply to each request with a message that the system will not be servicing their request for contact.

A user may initially be classified as an authorized user. However, through usage or the gathering of additional information, the user may be determined to be an undesirable user. In this situation, embodiments in accordance with the present invention would reclassify the user as an undesirable user and control the online access options such that the customer care options offered to authorized users are either not offered or are disabled or otherwise restricted for the reclassified undesirable users.

A challenge in developing an application to control online access is acquiring accurate data about users. Depending on the intended purpose of the control, different types of static and dynamic user persona and context data may be preferred. Explicitly involving a user in the procurement of the necessary data is undesirable, for a number of reasons as set forth below.

First, prompting the user for extensive data input results in effort and inconvenience, and may dissuade the user from adopting the application or taking full advantage of features offered by controlling online access. Asking the user may be counterproductive if the user realizes that being more forthcoming may be detrimental, e.g., if the additional information results in less access or functionality provided to the user. The user may also choose to skip or cancel the data collection, and important user persona or context elements may remain unknown. The user may also be tempted to engage in puffery or outright lies in order to improve their access or functionality.

Second, these user tendencies are even more likely if a large number of web applications to control online access prompt the user for the same information. The effort and time necessary for users to work with web applications that control online access may well outweigh the perceived benefits of the applications and lead to a broad rejection of the concept by users.

Third, transparently detecting changes in a user's persona is difficult, and prompting the user for manual updates on a regular basis may aggravate the first and second issues.

Fourth, user-entered information may be less accurate than desired because the effort in entering the information may tempt the user to become careless or to exaggerate during data entry. As the user responds to the prompts for information, an underlying distrust of the application's intent in prompting the user for all this personal information may surface and may make the user deliberately enter incorrect information.

Embodiments in accordance with the present invention provide a system and method that compiles a user's social network context, and then classifies the user as a desirable or undesirable user based upon the compiled social network context, and then acts accordingly in different online environments. In accordance with one example embodiment a user who is identified as a potential malicious user may get a text reply such as “We are experiencing higher than expected influx of messages associated with your inquiry; please call our customer service department and we'll be happy to assist you in person.” In accordance with yet another example embodiment a user who may initially receive a click to talk URL may later be denied access to agents and the system would automatically post a message on his social page advising him, e.g., “We are experiencing higher than expected influx of messages associated with your inquiry; please call our customer service department and we'll be happy to assist you in person.” The acts may include differentiated levels of customer care and support.

Embodiments in accordance with the present invention provide a system that collects, within a user's social network context, substantially all static, semi-static, and dynamic user attributes and utterances on a social network that the system can gain access to. Static attributes include, for example, the user's name and gender. Semi-static attributes include, e.g., the user's work/residence location. Dynamic user attributes include, for example, the user's sentiments towards this business as expressed in social network posts and from an identification of the IP address(es) from which the user accesses a social network. The degree to which a system can collect a user's social network context depends on factors such as:

(a) what data the social network stores;

(b) the programmatic access it provides to applications;

(c) what access to the context the user grants to the system; and

(d) how much the user has disclosed about himself/herself on the social network and what posts (s)he has made.

Classification of a suspect user based on the social network context attributes that have been gathered can be performed in multiple ways. For example, a system in accordance with an embodiment of the present invention can match the suspect user context attributes against an exclusion list, in order to prevent a malicious user who is not within the target demographic of the business from triggering a business response on the social network.

A system in accordance with an embodiment of the present invention may also review the number and frequency of postings and accesses to online resources from a suspect user, and exclude any suspect user who exceeds a maximum configured threshold. The system can analyze the suspect user's social network context for signs that the suspect user pretends to be somebody who (s) he is not. For example, if the suspect user's name does not match any known names and the suspect user has not provided a profile picture and the residence location does not exist, there is a good chance that the suspect user's self representation on the social network does not match the true user's persona. The business may want to exclude such suspect users from consideration. If a suspect user accesses the social network from an IP address that has been previously linked to some security attack, the user may be excluded as well.

To facilitate the detection of malicious users, participating businesses may pool and share data that their systems collect about users, together with the users' social network identities, thereby allowing participating businesses to have access to the pooled and shared data.

Embodiments in accordance with the present invention provide a system and method for identifying malicious and/or undesirable users, and excluding them from establishing connection with live agents. Embodiments in accordance with the present invention also provide a system and method for identifying non-malicious users, and facilitating communication of non-malicious users with live agents.

Once the system has classified a user as unauthorized, the system blocks the communication with the undesirable user. In accordance with an embodiment of the present invention, the system and method may notify a business representative (e.g., an agent) who is tasked with responding to social network posts of this fact. The system may also disclose the reason for excluding the user and thus give the business representative an opportunity to correct the system's decision. The business representative may choose, for instance, not to respond to the social network posts from undesirable users, or trigger some form of template-based response that decreases the business involvement, online and offline, with this user, or so forth.

If a business has an online presence on Web pages outside the social network and the Web pages are linked with the social network in such a way that a Web page visitor can be identified as a specific social network user, the classification of the user by the system can be used for generating different versions of Web pages to different visitors. The linkage of web pages with the social network is implemented by use of an online access control platform (“OACP”). The OACP is a new innovative and sophisticated system that continuously and automatically monitors the public social media via a well known interface. The OACP then assess the cyber threats that arise from requests to contact the Call Center in response to an online post, and helps filter out contact requests which are deemed to originate from malicious users.

For example, web pages may allow a user to sign in by providing a set of Facebook or LinkedIn login credentials. Visitors who belong to the authorized category can be shown the full Web page including access to contact center resources, business representatives, and otherwise costly online or offline resources. Undesirable visitors, on the other hand, may receive a scaled-down version of the Web pages without access to such resources. In accordance with a preferred embodiment customers who are deemed to be non-malicious will be cleared for service with a live agent upon clicking on a push to talk URL. Similarly, customers who are deemed to be potentially malicious will not be cleared for service with a live agent upon clicking on a push to talk URL.

The OACP makes the push to talk URL available in a public forum, e.g., in the public social media web pages where the customer service response has been posted. As a public posting, any Internet user can see and click on the URL on the public social media web page. Embodiments in accordance with the present invention limit the functionality of the push to talk URL such that malicious users will be limited in their ability to use the push to talk URL to place malicious calls to the contact center. Embodiments in accordance with the present invention therefore provide a more efficient utilization of Contact Center resources.

Compared to the known background art, embodiments in accordance with the present invention provide a system and method that allows an automatic classification of social network users/posters into categories of authorized and undesirable (i.e., unwanted) users. The system and method thus aids the business in the exclusion of certain unauthorized, undesirable, or even potentially malicious users from receiving customer service on the social network and through online resources. If the business links its Web pages back to the social network, the same system can prevent such users from accessing customer service and online resources on the Web pages by dynamically tailoring the Web pages such that no links to such resources are displayed, without requiring the user to log into an online account with the business.

Embodiments in accordance with the present invention provide a system and method that provides for the use of social network context as a new type of caller ID. Embodiments may automatically classify an individual in order to aid in an automatic, online detection of unauthorized, unwanted, and/or malicious usage of (or access to) online resources, including customer service.

Login credentials or other user information gathered from social media sources may be referred herein as user persona data. User persona data should be stored securely, safely, and efficiently, which is non-trivial. For all these reasons, controlling online access has traditionally relied on transparently collected persona and context data with a short-term validity. For example, many e-commerce Web applications record search terms recently entered by the user or monitor the user's recent navigation through their Web pages, mine these interactions with the Web application, and map them to controlled online access such as recommendations for additional or alternative products and services. When the user enters new search terms or changes the navigational path, these Web applications change the online access control accordingly. The user often benefits from this type of control of online access because it narrows a confusingly large and, for the user, mostly irrelevant number of products or services to a manageable and likely relevant subset. The business benefits because the user is less likely to abandon the product search without a purchase. Web usage mining and other forms of transparently collecting user persona and context elements can therefore be highly valuable for the user and for the provider of the web application to control online access.

However, less dynamic user persona elements may be just as useful in controlling online access via the appearance, content, and functionality of Web applications. Examples of such elements are name, language, age, birthday, address, time zone, gender, education, work history, expertise, disabilities, affiliations, and hobbies. Some examples are provided of the countless possibilities for controlling online access based on user profile information and/or other information available about the user, such as social network posts, number of friends, a list of places in to which the user has checked in, account metadata describing how frequently and from where the user logs in to the social network, the types of friends or other social connections the user has, and so forth. This information can even include differences between data in a public-facing profile and data in a more private profile for close friends. The system can even glean information about the user based on social networking data that is not explicitly disclosed. For example, the system can infer, based on a particular style of writing or vocabulary, an ethnicity, demographic, level of education, and so forth.

The web application can control online access by offering different communication modalities to connect a customer with customer service representatives: email, text chat, voice calls, and video chat. Different communication modalities incur different costs for the customer service operation, with email being the cheapest and video chat being the most expensive. The application could mine the customer's user profile to estimate the value that this customer brings to the business. If the customer has no prior history of patronage with this business, inspecting the customer's profession, education, interests, place of residence, and other user profile elements can be especially helpful in estimating the customer's value. For low-value customers, the application may enable email, text chat, and voice calls, and place access to these communication modalities in an inconspicuous location in the user interface. The application can present a high-value customer, on the other hand, with a “Can we help you? Click here to start a video chat!” button right after the customer has launched the application.

When insufficient information is available about a user, a web page may include one or more generic default online access links. The generic default links may include, for example, a telephone number and an email address for generic inquiries (e.g., info@domain.com).

As more information is mined from social networking sources that indicate that the user is a desirable customer (e.g., a member of a target demographic; being a trend setter; a history of providing positive feedback; spending patterns, etc.), online access links can be permitted and displayed which provide a better quality customer care (i.e., links that are more responsive, easier to use, etc.). For example, the telephone number might be replaced with a toll-free telephone number; the generic email address may be replaced with an email address to a specific agent; the email address may be displayed as a clickable link; other forms of customer care may be offered that are progressively more interactive, such as a text chat window, VoIP call, or video call; access to a discussion forum may be granted; and/or the contact may be handled with a higher priority (e.g., placing the contact near the top of a queue waiting for an agent).

Conversely, if information is mined from social networking sources that indicate that the user is not a desirable customer (e.g., not a member of a target demographic; profane or harassing posts, etc.), the online access links that are displayed can be downgraded below the generic default. For example, references to telephone numbers and email addresses may be removed. Alternatively, a display of the online access control may not change but responses from undesirable customers may be discarded, or the processing of such responses may otherwise be blocked.

One key feature of most social networks is a user profile, and most social networks offer an application programming interface (API) that provides access to user profiles after proper user authorization. To these applications, the social network represents, among other things, an external application-independent and domain-independent user profile manager. The subscribers of the social network typically have a strong interest in keeping their user profiles up-to-date because a well-maintained profile is crucial for the accurate self-representation in an online social fabric and thus vital to the users' goals for being part of the social network. A user is likely to update her photo album in the social network after a vacation or festivity, the place of residence after a move, education history after receiving a degree or diploma, work history after changing jobs, the list of favorite movies and books, interests and hobbies, activities, relationship details, and so on.

By accessing a user profile in the social network, an application can thus gain relatively accurate insights into the user persona without having to prompt the user for such information and without the burden of securely, safely, and efficiently storing user profiles. Furthermore, since the user profile is managed externally, every application can access it the same way and benefit from it, so long as the user provides authorization for the application to access their user profile on the social network. However, one potential pitfall of mapping user profile elements to controlling online access is misunderstanding some aspects of the user during such online access control can alienate the user. If an application mistakenly identifies a 70 year old poet as a starving artist and in reality he is affluent trendsetter, providing inferior customer service through inadequate online links is misplaced and may send the poet to a competing business.

Some users may become suspicious when the Web application asks for access to the user profile and therefore disallow it, thus making online access control based on a user profile impossible or very difficult. Yet others may allow it but experience an uncomfortable sensation if online access control is very obvious and is perceived as invading the user's privacy.

A programming platform for controlling online access to aspects of web and other applications can support the rapid development of web and other applications based on user profiles stored in external social networks.

One function of the online access control programming platform is to acquire user profiles from a social network and to map them to objects, such as Java objects. The objects can be available to the online access control web application in a simple and efficient way. Because many data points in a user profiles change only infrequently, a caching mechanism for user profiles can increase the efficiency of repeat profile retrieval and can be incorporated in the platform. Online access control of a Web application can continue beyond loading the user interface links into the user's browser. Whenever the application regenerates parts of or the entire user interface, when triggered by user input (button clicks, hyperlink clicks, etc.) or asynchronously, the application can control the online access to the new interface components and therefore access the user profile again. User profile caching is not only important for enhancing platform efficiency but also for avoiding any limits on the number of accesses to the social network API that the social network provider may impose. Java methods described herein are only for illustrative purposes and should not be viewed as limiting preferred embodiments in accordance with the present invention.

The higher the degree of online access control in a Web application without explicit user involvement is, the higher the risk is to perform a counterproductive online access control. Using outdated user profile data in the online access control process aggravates this risk. It is important, therefore, that an online access control programming platform regenerates the application's user interface whenever a user launches the application and that the online access control process uses a recent version of the user's profile.

Public social networks typically require explicit user approval before an application is allowed to retrieve the user's profile through the social network API. Thus, user authentication in the social network and authorization for profile access is one common requirement for the type of online access control that the platform is intended to support and should therefore be implemented by the platform. Developers can restrict access to an application to a specific set of users. For example, an online access control web application may be accessible from the public Internet but may be meant to serve only the employees of a specific enterprise. Furthermore, the platform should support an explicit user login into an enterprise portal, and the explicit login can be controlled as well. An explicit login allows the application to obtain more information about the user than would be possible with the user's social network profile alone. An example of such information is past transactions that the user had with the enterprise. The user can authenticate with the social network as part of an account creation process in connection with the application, or at the time of first use of the application, for example. In the event that a user does not desire to authenticate, the application can continue to operate and control, to the extent possible, using publicly available or indexable information, which does not require explicit authorization to access, from one or more social network service.

The process to control online access can map user profiles to access control elements. Often, the desired online access control in Web applications affects only or mostly the application's user interface, rather than the structure or operation of the application backend which can also be affected based on a user's profile. For example, user interface elements can be controlled for effectiveness, or so that the highest-value users can be provided the most responsive customer care options. Access to a user's social network profile allows deep insights into the user's persona. However, with this new potential for online access control comes the danger of a vastly increased effort to build Web applications.

For many online access links, access to the same type of a control often applies to a group of users and not just to one individual user. In fact, considering the potentially very large number of users for a Web application, this situation is typical and not the exception. For example, if an online access control rendered by a Web application is to be presented according to users' locations based upon their IP addresses, such as North America (safe), Western Europe (safe), Eastern Europe (unsafe), Asia (unsafe) and rest of the world (potentially unsafe), the application can segment its online access links into three categories based on the IP address and for each segment provide a specific level of online access control.

If the profile of a user does not contain the information that forms the basis for modalities for controlling online access, the control can default to a generic appearance, content, and functionality. Many users, for example, do not specify their age or birth date in their profiles. Generic defaults are also important in situations where access control is intended only for a small subset of users. For example, if a retail chain catering to a particular demographic wants to provide superior customer service at for a new store location as part of a Web application, it would make sense to allow only customers in the vicinity of the new location and within the target demographic of the enhanced customer care while others might see a generic marketing statement. Alternatively, the system can guess certain information about the user. For example, if the user has not entered a birth date, but has entered a high school graduation year, the system can reasonably reliably infer a relatively narrow range of possible birth dates, and consequently ages. The system can also infer a likely range of values for missing information for a particular user based on social network profile data of others, such as a spouse, children, or friends of the user.

An aspect of efficiency in mapping user profiles to online access links is run-time efficiency. Customizing online access links may consume valuable time and hardware resources, and consequently longer application launch times, which can negatively affect the user experience. Further, the additional hardware resources can lead to increased equipment and operational expenses. Analogous to caching social networking profile data, the platform can cache all or some access control elements for a specified time period so that repeat access to the application by the same user does not result in repeat work for the access control platform.

FIG. 2 illustrates an example architecture 200 and operation for an online access control platform (“OACP”). An exemplary sequence of events that take place when a user interacts with a personalized OACP web application 202 outlines the function of the various OACP components and their interplay. The OACP components' functions are not confined to any specific application domain or purpose.

Certain components 210, 212, 214, 216, 218, 220, 228, 230, 234, 236, 240, 244, 246 250 are part of OACP, whereas other components 226, 224, 232, 238, 242, 248 can be supplied by the application developer. This example architecture contains a small Java API of four simple Java interfaces that allow the developer to customize OACP by providing the other components inside the OACP boundary 202. An OACP application is an extension of OACP and starts its own copy of OACP. Therefore, the other components in FIG. 2 are specific to a particular personalized web application. In the description of events, the application is assumed to be accessed via a user's browser 204 from the public Internet 206 and not from an enterprise Intranet. Access from an Intranet would connect the user's browser 204 directly with the OACP request manager 214 instead of traveling through the tunneling server 210 and Client 212.

The tunneling server 210 can be deployed in the enterprise demilitarized zone (DMZ) 208 as a DMZ conduit for all HTTP requests from the user's browser 204 to the OACP application 202 and does not contain any code or resources specific to a personalized web application. The tunneling server 210 allows the placement of all other OACP components and of the personalized web application and its resources on the private enterprise network and therefore protects them against direct access from the public Internet 206.

OACP can start by launching the tunneling server 210 first and then the other OACP components on the enterprise network. The tunneling client 212 establishes a secure TCP connection to the tunneling server 210 through the enterprise firewall. The tunneling server 210 can transmit a periodic heartbeat signal to the tunneling client 212 over this connection. Upon signal receipt, the tunneling client 212 returns the signal to the tunneling server 210. If the tunneling client 212 does not receive the signal within a specified time window, it will attempt to re-establish the connection with the tunneling server 210 until it succeeds. If the tunneling server 210 does not receive the expected response to its heartbeat signal within a specified time window, it returns to a standby mode where it waits for the tunneling client 212 to re-establish the secure TCP connection. During this time, the tunneling server 210 responds to HTTP requests for the application with a specified default HTML page that indicates application unavailability. This way, the tunneling server 210 and tunneling client 212 automatically tolerate firewall outages, hardware reboots, OACP component restarts, and other intermittent failures or maintenance tasks.

Before continuing with the description of the tunneling mechanism, the discussion turns briefly social network authentication and authorization mechanisms. OAuth is one popular JavaScript-based authentication and authorization protocol in social networks, and the examples assume that the social network 222 uses OAuth. However, other suitable replacements for OAuth can be substituted. The tunneling server 210 can load an HTML page with customized OAuth JavaScript code and return it to the user's browser 204 at application launch. Through the HTML page, the user can log authenticate with the social network 222 if she is not already logged in, and authorize the application to retrieve her user profile from the social network 222 via OAuth or other API calls. OAuth then generates a token that, along with the user's social network identifier, can be passed to OACP as an HTTP request parameter.

After the authentication and authorization step, the HTML page redirects to OACP. The resulting HTTP request travels through the public Internet 206 and arrives at the tunneling server 210. The tunneling server 210 informs the tunneling client 212 through the secure TCP connection of a new HTTP request for the application. The tunneling client 212 opens a new, secure TCP connection to the tunneling server 210, and the tunneling server 210 creates a new thread that forwards the HTTP request to the tunneling client 212 over the newly established TCP connection. This connection remains open until the tunneling client 212 has sent a response to the HTTP request back to the tunneling server 210. This mechanism ensures that the tunneling server 210 can receive and forward new HTTP requests while others are being processed by OACP. The tunneling client 212 also creates a session object, and OACP can add string properties to it at any time. The session object is part of the response that the tunneling client 212 eventually sends back to the tunneling server 210. The tunneling server 210 translates this object into an HTTP session that OACP uses in subsequent HTTP requests to identify the user and maintain other session state. To this end, the tunneling server 210 retrieves the session object from the HTTP session and sends it along with any new HTTP request to the tunneling client 212.

The tunneling client 212 forwards every HTTP request for the application to the request manager 214. The request manager 214 orchestrates the processing of each request through various OACP components. The request manager 214 retrieves any HTTP request parameters and the current session object that the tunneling client 212 created or obtained from the current HTTP session. At application launch, the request manager 214 adds the user's social network identifier and access token to the session object for use in future requests from the same user, thereby obviating the need for repeat invocations of the authentication handler 224. The request manager 214 checks whether the user is authorized to access the application via the white/blacklist manager 216 and/or the authentication handler 214. The request manager 214 obtains the user's social network profile from the user profile cache 218, if any, and invokes the personalization generators 226, 228. Eventually, one of the personalization generators 226, 228 returns a string that represents a personalized HTML page, JavaScript code, or CSS specification. The request manager 214 returns this string to the tunneling client 212, from which the string travels back to the user's browser 202 through the tunneling server 210 and the Internet 206.

OACP can be configured to check application users against a whitelist or blacklist via a white/blacklist manager 216. The request manager 214 forwards HTTP requests for launching the application to the white/blacklist manager 216. If the application provider wants to restrict access to the application to a group of provisioned users, the white/blacklist manager 216 checks whether the user's social network identifier is included in the whitelist. If not, the request manager 214 returns an error message to the user and/or can simply fall back on default values or an unpersonalized interface. If the application provider wants to exclude certain individuals from accessing the application, the white/blacklist manager 216 checks whether the user's social network identifier is included in the blacklist. If so, the request manager 214 can return an error message to the user or simply return the non-personalized version of the website. A whitelist or blacklist can be a file, a database table, or a web service. The whitelist or blacklist can be based on components of a social networking profile instead of a predetermined list of specific social networking accounts. For example, if the name listed in the social network profile includes profanity, then the blacklist can block that entire social network profile or just specific parts.

If the user has cleared the optional check performed by the white/blacklist manager 216, the request manager 214 will instruct the user profile cache 218 to retrieve the user's social network profile. If the user profile cache 218 detects a cache miss, it retrieves the profile from the social network through the social network adapter 220. The social network adapter 220 can be implemented according to the API of one or more public or private social network. After the social network profile is retrieved, the social network adapter 220 creates an object whose fields represent the entries of the user's profile. The object is then stored in the user profile cache 218.

When the user profile cache 218 reaches its configured capacity for storing entries, it can evict cache entries based on a least recently used strategy or other appropriate cache management algorithm. For example, the user profile cache 218 can employ a check-pointing mechanism to tolerate OACP reboots without the need for re-fetching previously cached user profiles. Cache entries can expire after a specified time period, such as a few days or some other period. This approach can expedite repeat accesses to the user's social network profile.

OACP can offer the application provider the option of adding an explicit user login into an enterprise security system. If OACP is configured for an explicit user login, the request manager 214 can instruct the personalization generator 228 to return a dedicated, personalized login HTML page. The process for producing the login page is exactly the same as for any other personalized HTML page that is part of the application. When the user submits her enterprise account credentials through the login HTML page, the request manager 214 eventually routes the resulting HTTP request to the authentication handler 224. The OACP API can include a simple interface that the authentication handler 224 implements. The authentication handler 224 interacts with the specific enterprise security system in order to verify a match between the user-supplied account name/password combination and the user credentials stored in the enterprise security system.

The application developer can build a custom personalization generator 226 that assembles a personalized response to an HTTP request. The OACP API can include an interface that the custom personalization generator 226 implements. If a custom personalization generator 226 is deployed, the request manager 214 invokes it with the HTTP request, current session object, and the user's social network profile as parameters. For example, the user interface of the application may contain AJAX code that dynamically updates a <div> in the user interface with local weather information. To generate the updated <div>, the custom personalization generator 226 retrieves weather information for the user's location from a weather web Service, assembles an HTML snippet with the weather information in the user's preferred language, and returns the HTML snippet as a string to the request manager 214.

If no custom personalization manager 226 is deployed or if it returns a null response, indicating it does not or is unable to handle the current HTTP request, the request manager 214 calls the OACP personalization generator 228 with the current HTTP request, session object, and the user's social network profile as parameters. The OACP personalization generator 228 orchestrates the assembly of personalized HTML pages, JavaScript code, and CSS specifications, for example, and returns them to the request manager 214. First, the OACP personalization generator 228 checks whether the requested object exists in the page cache 230. If so, the OACP personalization generator 228 returns the cached object to the request manager 214. If not, it uses the services of various subcomponents to generate a personalized HTML page, JavaScript code, or CSS specification, for example, and stores it in the page cache 230, and returns it to the request manager 214.

The page cache 230 can store previously generated personalized HTML pages, JavaScript code, and CSS specifications. Whenever application resources change (HTML, JavaScript, or CSS templates) that affect the previously generated entries in the page cache 230, the OACP personalization generator 228 can automatically clear the page cache 230, thereby forcing a subsequent on-demand regeneration of its previous entries. If the OACP process is in danger of running out of memory, the page cache 230 can delete all or some of its entries automatically, such as based on a desired threshold level of available memory. The page cache 230 can accelerate the generation of personalized HTML pages, JavaScript code, CSS specifications, and other user interface elements.

The design of OACP can be illustrated by a set of personalized web applications called customer service widgets (CSWs). A business can deploy a CSW on a social network page to provide software-assisted, personalized customer service. The CSW helps establish live conversations between social network users and customer service representatives (agents) through voice, video, or text chat. The CSW offers access to a business knowledge base containing reported issues and solutions to help customers troubleshoot their problems with business products and services. The CSW can display news about the business, current promotions, coupons, marketing information, etc., all tailored to the customer and his or her presumed needs and interests. CSWs can assist in modernizing legacy customer service technologies and bringing customer service to social networks. Developers can build CSWs on OACP.

Embodiments in accordance with the present invention may offer a personalized selection of modalities (e.g., voice, chat) for communicating with an agent pops up in the CSW. Because a video connection to an agent incurs additional cost for the vendor, the system can only offered this option to high-profile or highly desirable customers, for example, and not to everyone. The expected wait times for an agent can be personalized as well, by preferential placement of high-profile or highly desirable customers in the call queue, and thus this customer's expected wait time can be partially determined by his perceived value as a customer to the vendor.

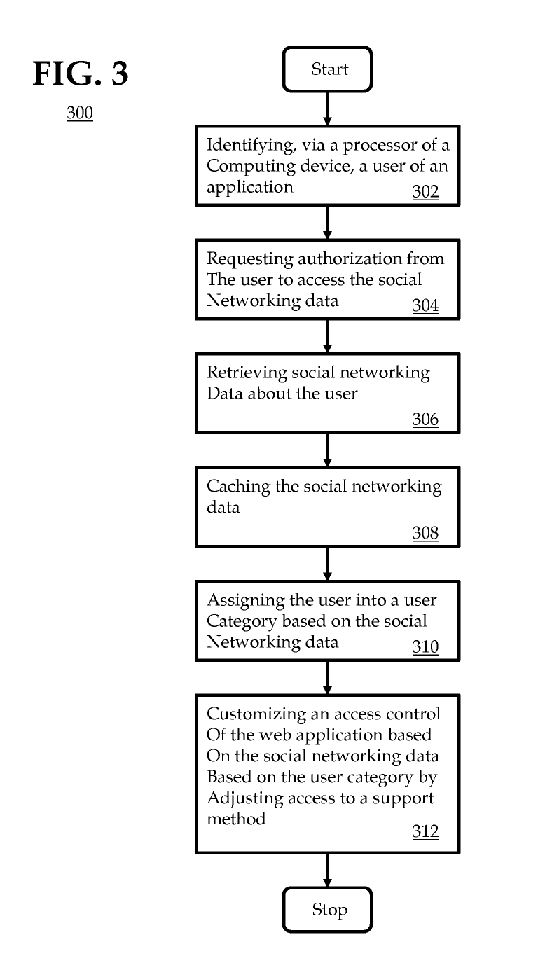

Having disclosed some basic system components and concepts, the disclosure now turns to the exemplary method embodiment 300 shown in FIG. 3. For the sake of clarity, the method is discussed in terms of an exemplary system 100 as shown in FIG. 1 configured to practice the method. The steps outlined herein are exemplary and can be implemented in any combination thereof, including combinations that exclude, add, or modify certain steps. The system first identifies a user of an application (302), such as by requesting the user to log in to or create a user profile. Alternatively, the system can identify the user based on a cookie, an existing session, a browser ‘fingerprint’ that uniquely identifies a particular browser, a network address, other identifying information, and/or a combination thereof. It should be noted that any step that requests a user to explicitly grant access to their private social network and/or share their private information or personal identification information may have a low rate of compliance. In such circumstances, an identification of the terminal rather than of the user of the terminal may be adequate.

The system optionally requests authorization from the user to access the social networking data (304), such as if all or part of the social networking data is private. Private data may include data that is available only upon logging in or otherwise providing identification credentials, and not available if sufficient and verified identification credentials are not provided. The system can request this authorization when a user creates a user profile, for example, and rely on that authorization for subsequent personalization efforts. The system can also request this authorization from the user upon the first attempt by the system to personalize the user interface. The system retrieves social networking data about the user (306), such as through a social network API, cache, a ‘scraper’ that extracts information from a publicly available social networking source, and/or social networking aggregator. Other sources of information can also be used. When the system receives this social networking data, it can proceed to cache the social networking data (308) in order to save on bandwidth and/or to keep traffic or requests within the terms of service of a social networking API.

The system can assign the user into a user category based on the social networking data (310), and customize an online access control of the application based on the social networking data and/or the user category by adjusting at least one of type, functionality, location, size, and appearance of a user interface element (312). The adjustment may include removal of the user interface element 312. The user interface element can be a non-advertising layout element including text, font, font size, an image, a color, a thickness, position, arrangement, orientation, transparency, and/or any other attribute of a displayable user interface element. The system can customize the user interface by mapping custom variables based on the social networking data.

The programming platform OACP for personalized web applications. OACP is based on the idea of obtaining detailed information about application users from a public or private social network where a plethora of such information is stored in the form of user profiles. The OACP approach therefore complements existing personalization technologies that automatically collect information about users while users interact with the application or explicitly prompt users for information. The OACP programming model enables developers to easily incorporate personalized elements in an application based on retrieved user profiles. The main goals of OACP are utmost simplicity of learning and using the platform, as well as general applicability of the platform to all types of personalized web applications. We described the set of goals for OACP and showed how its architecture meets these goals. We have developed several real personalized web applications on OACP that we call customer service widgets, and we illustrated the use of OACP through a sample customer service widget. Some challenges remain to be met by OACP. Among them is a lack of a development environment that would assist the developer in building XML default variable mappings specifications. Currently, this is a tedious manual task. We also want to refine and validate the OACP design by broadening the class of applications that we have built with OACP. At this time, all OACP applications that were built are customer relationship management or enterprise information applications.

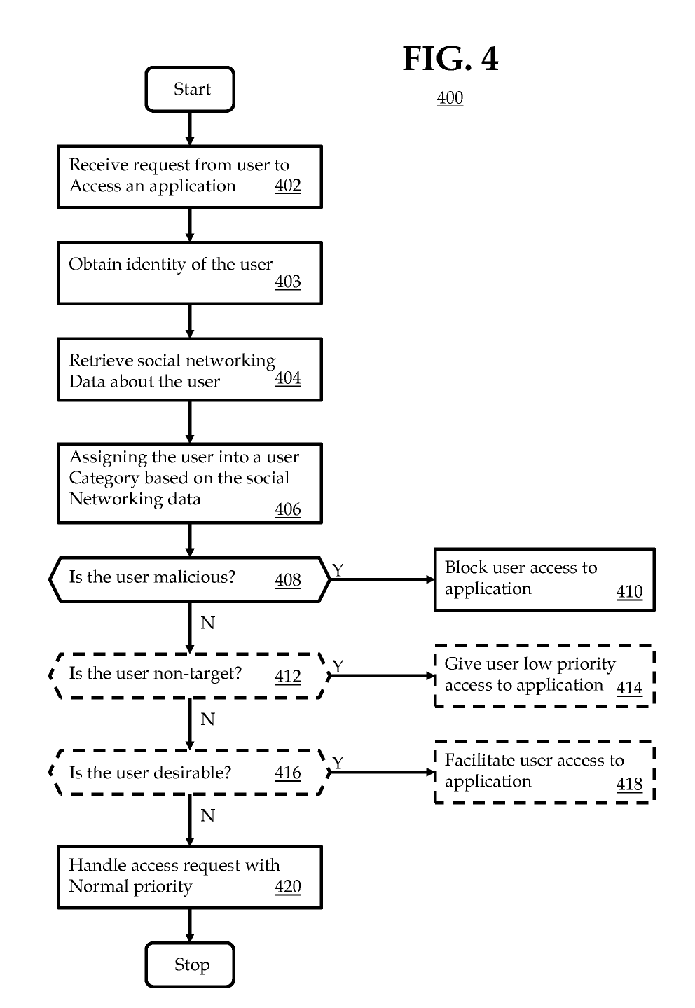

FIG. 4 illustrates a method 400 of granting access in accordance with an embodiment of the present invention. At step 402, a request is received from a user to access an application. The request may be, for example, an HTTP message that the user has clicked on a URL that is labeled or otherwise indicated as clickable in order to invoke an application, and in particular a customer support application. The customer support application may be, e.g., a chat request, a VoIP phone call request, a textual form for online submission, and so forth.

At step 403, the user is identified, for example by use of methods described above with respect to step 302 of FIG. 3. User identity may include identity of the terminal from which the request originated and/or identity of the person using the terminal.

At step 404, social networking data about the user is retrieved. Methods of identifying the user are disclosed at least with respect to method 300 of FIG. 3. Social networking data is retrieved at least by use of OACP, as disclosed above.

At step 406, the user is assigned to a category, based at least upon the social networking data and the analysis of it by OACP. The categories may include at least whether the user is malicious. Additional categories may be included, such as whether the user is non-target and/or whether the user is desirable.

At steps 408, 412 and 416, actions are taken if the user falls within certain categories. As illustrated in FIG. 4, at step 408 if the user has been determined to be malicious, then control of method 400 proceeds to step 410 at which access to the application by the user is blocked. At optional step 412, if the user has been determined to be non-target as discussed earlier, then control of method 400 proceeds to step 414 at which access to the application by the user is given low priority. For example, the low-priority user may be placed at the end of a queue or placed in a separate low-priority queue. At optional step 416, if the user has been determined to be desirable, then control of method 400 proceeds to step 418 at which access to the application by the user is facilitated. For example, the facilitated user may be placed at the top of a queue or placed in a separate high-priority queue.

Category testing as represented by steps 408, 412 and 416 may be performed in any order, under the condition that if one category is a subset of another category, then the narrower category will be tested first. For example, since a malicious user may also be consider as a non-target user, then malicious (step 408) is tested before non-target (step 412), rather than non-target before malicious. On the other hand, desirable (step 416) could be tested before malicious.

If the user does not fall into any of the categories tested in steps 408, 412 and 416, then control of method 400 proceeds to step 420, at which access to the application by the user is given normal priority.

Embodiments within the scope of the present disclosure may also include tangible and/or non-transitory computer-readable storage media for carrying or having computer-executable instructions or data structures stored thereon. Such non-transitory computer-readable storage media can be any available media that can be accessed by a general purpose or special purpose computer, including the functional design of any special purpose processor as discussed above. By way of example, and not limitation, such non-transitory computer-readable media can include RAM, ROM, EEPROM, CD-ROM or other optical disk storage, magnetic disk storage or other magnetic storage devices, or any other medium which can be used to carry or store desired program code means in the form of computer-executable instructions, data structures, or processor chip design. When information is transferred or provided over a network or another communications connection (either hardwired, wireless, or combination thereof) to a computer, the computer properly views the connection as a computer-readable medium. Thus, any such connection is properly termed a computer-readable medium. Combinations of the above should also be included within the scope of the computer-readable media.

Computer-executable instructions include, for example, instructions and data which cause a general purpose computer, special purpose computer, or special purpose processing device to perform a certain function or group of functions. Computer-executable instructions also include program modules that are executed by computers in stand-alone or network environments. Generally, program modules include routines, programs, components, data structures, objects, and the functions inherent in the design of special-purpose processors, etc. that perform particular tasks or implement particular abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

The disclosed methods may be readily implemented in software, such as by using object or object-oriented software development environments that provide portable source code that can be used on a variety of computer or workstation platforms. Alternatively, the disclosed system may be implemented partially or fully in hardware, such as by using standard logic circuits or VLSI design. Whether software or hardware may be used to implement the systems in accordance with various embodiments of the present invention may be dependent on various considerations, such as the speed or efficiency requirements of the system, the particular function, and the particular software or hardware systems being utilized.

While the foregoing is directed to embodiments of the present invention, other and further embodiments of the present invention may be devised without departing from the basic scope thereof. It is understood that various embodiments described herein may be utilized in combination with any other embodiment described, without departing from the scope contained herein. Further, the foregoing description is not intended to be exhaustive or to limit the invention to the precise form disclosed. Modifications and variations are possible in light of the above teachings or may be acquired from practice of the invention. Certain exemplary embodiments may be identified by use of an open-ended list that includes wording to indicate that the list items are representative of the embodiments and that the list is not intended to represent a closed list exclusive of further embodiments. Such wording may include “e.g.,” “etc.,” “such as,” “for example,” “and so forth,” “and the like,” etc., and other wording as will be apparent from the surrounding context.

No element, act, or instruction used in the description of the present application should be construed as critical or essential to the invention unless explicitly described as such. Also, as used herein, the article “a” is intended to include one or more items. Where only one item is intended, the term “one” or similar language is used. Further, the terms “any of” followed by a listing of a plurality of items and/or a plurality of categories of items, as used herein, are intended to include “any of,” “any combination of,” “any multiple of,” and/or “any combination of multiples of” the items and/or the categories of items, individually or in conjunction with other items and/or other categories of items.

Moreover, the claims should not be read as limited to the described order or elements unless stated to that effect. In addition, use of the term “means” in any claim is intended to invoke 35 U.S.C. §112, ¶6, and any claim without the word “means” is not so intended.

What is claimed is:

1. A method to control access by a user to an online service,
comprising: receiving a request from a user to use an application;
identifying, via a processor of a computing device, a social networking characteristic of the user;
classifying the user to one of a set of classifications based upon the social networking characteristic, to produce a classification of the user, wherein the set of classifications comprises preferred, non-target and malicious; and
controlling a level of access to the online service based upon the classification of the user.

2. The method of claim 1, wherein the social networking characteristic comprises a geographic source identifier of other posts from the user.

3. The method of claim 1, wherein the social networking characteristic comprises an IP address of the user.

4. The method of claim 1, wherein the social networking characteristic comprises a subnet address of the user.

5. The method of claim 1, wherein the social networking characteristic is publicly available.

6. The method of claim 1, wherein the social networking characteristic is private, the method further comprising:
requesting authorization from the user to access the social networking characteristic.

7. The method of claim 1, wherein controlling an access comprises permitting the user to use the online service.

8. The method of claim 1, wherein controlling an access comprises discarding a request from the user to use the online service.

9. The method of claim 8, further comprising the step of posting a notification message on a social media, to notify the user that the request was denied as having been originated from a malicious user.

10. The method of claim 1, wherein controlling an access comprises determining whether to display an online link to the user to use the online service.

11. The method of claim 1, further comprising:
classifying the user as one of a malicious user and a non-target user, based upon the social networking characteristic; and
controlling an access permission by impeding access to the online service.

12. The method of claim 1, further comprising:
classifying the user as a target user, based upon the social networking characteristic; and
controlling an access permission by facilitating access to the online service.

13. A system to control access by a user to an online service, comprising:
a receiver configured to receive a request from a user to use an application;
a processor of a computing device configured to identify a social networking characteristic of the user;
a classifier module configured to classify the user to one of a set of classifications based upon the social networking characteristic, to produce a classification of the user, wherein the set of classifications comprises preferred, non-target and malicious; and
a control module configured to control a level of access to the online service based upon the classification of the user.

14. The system of claim 13, wherein the social networking characteristic is publicly available.

15. The system of claim 13, wherein the social networking characteristic is private, the system further comprising:
requesting authorization from the user to access the social networking characteristic.

16. The system of claim 13, wherein controlling an access comprises permitting the user to use the online service.

17. The system of claim 13, wherein controlling an access comprises discarding a request from the user to use the online service.

18. The system of claim 17, further comprising a module configured to notify the user that the request was denied as having been originated from a malicious user.

19. The system of claim 13, wherein controlling an access comprises determining whether to display an online link to the user to use the online service.

20. The system of claim 13, further comprising:
classifying the user as one of a malicious user and a non-target user, based upon the social networking characteristic; and
controlling an access permission by impeding access to the online service.

21. The system of claim 13, further comprising:
classifying the user as a target user, based upon the social networking characteristic; and
controlling an access permission by facilitating access to the online service.
